(19) United States
(12) Patent Application Publication
(10) Pub. No.: US 2023/0318990 A1
(43) Pub. Date: Oct. 5, 2023

(54) ETHERNET CABLE OPEN CIRCUIT CHECKING

(71) Applicant: Lenovo Global Technology (United States) Inc., Morrisville, NC (US)

(72) Inventors: Corneliu-Ilie Calciu, Bucharest (RO); Catalin Nitipir, Bucharest (RO); George-Andrei Stanescu, Ilfov (RO); Radu Mihai Iorga, Bucharest (RO)

(21) Appl. No.: 17/707,737

(22) Filed: Mar. 29, 2022

(51) Int. Cl. H04L 49/00; H04L 69/08; H04L 49/351

(52) U.S. Cl. CPC H04L 49/3054; H04L 69/08; H04L 49/351

(57) ABSTRACT

A method for detecting an open circuit on a cable for 1GBASE-T and/or 10GBASE-T Ethernet communications includes transmitting one or more autonegotiation signals during an attempt to identify an open cable. The autonegotiation signals are sent from an autonegotiation-capable Ethernet transceiver connected to a cable with a twisted pair. The method includes receiving one or more waveforms from the cable, analyzing the received one or more waveforms, and transmitting an open cable alert in response to determining that the received one or more waveforms are indicative of a reflected autonegotiation signal.

### FIELD

The subject matter disclosed herein relates to 1GBASE-T and/or 10GBASE-T Ethernet communication and more particularly relates to detecting an open circuit on a cable for 1GBASE-T and/or 10GBASE-T Ethernet communication.

### BACKGROUND

Gigabit Ethernet includes transmitting Ethernet frames at a rate of at least gigabit per second. Gigabit Ethernet and 10 gigabit Ethernet are often used in datacenters because of the high data rates and low cost of cables. While higher transmission rates are possible, such as 100 gigabits per second, higher speed Ethernet transmission requires direct attach cable (“DAC”) with a transceiver at each end of the cable. Active optical cables (“AOC”) may also be used for higher speed Ethernet. The most popular variant of gigabit Ethernet is 1000BASE-T or 1GBASE-T and the most popular variant of 10 gigabit Ethernet is 10GBASE-T. 1GBASE-T is defined by the Institute of Electrical and Electronics Engineers (“IEEE”) 802.3ab standard and 10GBASE-T is defined by the 802.3ae-2002 standard. Both 1GBASE-T and 10GBASE-T are able to use a registered jack 45 (“RJ45”) connector and twisted pair copper cable. 1GBASE-T uses copper cable with a category (“cat”) 5e or better rating and 10GBASE-T uses copper cable with a cat 6 of better rating. Copper cable for 1GBASE-T and 10GBASE-T come in unshielded twisted pairs (“UTP”) and shielded twisted pairs (“STP”).

Using copper cable with an RJ45 connector is desirable in certain applications, including datacenters, where a lot of cable is used due to the low cost of the copper cable terminated in RJ45 connectors in comparison with DAC cables and other cables with a transceiver at each end. A large number of network issues are triggered by link failures. Such failures can have multiple sources like network equipment configuration changes, port configuration attributes changed due to firmware upgrades, cable mechanical failures, maintenance triggered problems due to human intervention on cabling infrastructure, etc.

The physical access of a human operator in a datacenter or similar facility can be limited by several factors, like distance to get into the facility, epidemic situations, security, and the like. Solutions to enhance the remote debuggability of a failing link status will help improve the time needed to resolve network issue and reduce unnecessary costs. DAC, AOC, and similar adapters with a transceiver have an ability to determine various failure types, such as a faulty connection. However, UTP and STP copper cables terminated with an RJ45 connector currently do not have a way to check for a common occurrence of an open circuit at one end or the other of the cable caused by an improper termination. For example, an RJ45 connector may not be pushed in far enough for proper termination. Some transceivers include a time domain reflectometer (“TDR”), which provides a mechanism for determining various cable issues, such as an open circuit. However, including a TDR for each port of a transceiver is expensive.

### BRIEF SUMMARY

A method for detecting an open circuit on a cable for 1GBASE-T and/or 10GBASE-T Ethernet communication is disclosed. An apparatus and computer program product also perform the functions of the method. The method includes transmitting one or more autonegotiation signals during an attempt to identify an open cable. The autonegotiation signals are sent from an autonegotiation-capable Ethernet transceiver connected to a cable with a twisted pair. The method includes receiving one or more waveforms from the cable, analyzing the received one or more waveforms, and transmitting an open cable alert in response to determining that the received one or more waveforms are indicative of a reflected autonegotiation signal.

An apparatus for detecting an open circuit on a cable for 1GBASE-T and/or 10GBASE-T Ethernet communication includes a transmitter of an autonegotiation-capable Ethernet transceiver configured to transmit one or more autonegotiation signals during an attempt to identify an open cable. The transceiver is connected to a cable with a twisted pair. The apparatus includes a receiver of the transceiver configured to receive one or more waveforms from the cable, and a pulse analyzer of the transceiver configured to determine whether the received one or more waveforms are indicative of a reflected autonegotiation signal. The apparatus includes an open alert module configured to transmit an open cable alert in response to the pulse analyzer determining that a plurality of received waveforms are not valid autonegotiation signals.

A program product for detecting an open circuit on a cable for 1GBASE-T and/or 10GBASE-T Ethernet communication includes a non-volatile computer readable storage medium storing code. The code is configured to be executable by a processor to perform operations that include transmitting one or more autonegotiation signals during an attempt to identify an open cable. The autonegotiation signals are sent from an autonegotiation-capable Ethernet transceiver connected to a cable with a twisted pair. The operations include receiving one or more waveforms from the cable, analyzing the received one or more waveforms, and transmitting an open cable alert in response to determining that the received one or more waveforms are indicative of a reflected autonegotiation signal.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for detecting an open circuit on a cable for 1GBASE-T and/or 10GBASE-T Ethernet communications, according to various embodiments;

FIG. 2 is a schematic block diagram illustrating an apparatus for detecting an open circuit on a cable for 1GBASE-T and/or 10GBASE-T Ethernet communications in a server, according to various embodiments;

FIG. 3 is a schematic block diagram illustrating one embodiment of a PHY on each end of a 1GBASE-T and/or 10GBASE-T Ethernet communication capable cable, according to various embodiments;

FIG. 4 is a diagram illustrating a fast link pulses (“FLP”) for autonegotiation, according to various embodiments;

FIG. 5A is a diagram illustrating a pulse of a FLP signal and a reflected waveform, according to various embodiments;

FIG. 5B is a diagram illustrating a pulse of a FLP signal merged with a reflected waveform, according to various embodiments;

FIG. 6 is a schematic block diagram illustrating an apparatus for detecting an open circuit on a cable for 1GBASE-T and/or 10GBASE-T Ethernet communications, according to various embodiments;

FIG. 7 is a schematic block diagram illustrating another apparatus for detecting an open circuit on a cable for 1GBASE-T and/or 10GBASE-T Ethernet communications, according to various embodiments;

FIG. 8 is a schematic flow chart diagram illustrating one embodiment of a method for detecting an open circuit on a cable for 1GBASE-T and/or 10GBASE-T Ethernet communications, according to various embodiments; and

FIG. 9 is a schematic flow chart diagram illustrating another method for detecting an open circuit on a cable for 1GBASE-T and/or 10GBASE-T Ethernet communications, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission. The storage devices, in some embodiments, do not embody signals.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for detecting an open circuit on a cable for 1GBASE-T and/or 10GBASE-T Ethernet communications is disclosed. An apparatus and computer program product also perform the functions of the method. The method includes transmitting one or more autonegotiation signals during an attempt to identify an open cable. The autonegotiation signals are sent from an autonegotiation-capable Ethernet transceiver connected to a cable with a twisted pair. The method includes receiving one or more waveforms from the cable, analyzing the received one or more waveforms, and transmitting an open cable alert in response to determining that the received one or more waveforms are indicative of a reflected autonegotiation signal.

In some embodiments, the method includes transmitting one or more autonegotiation signals during an attempt to establish an Ethernet communication link. The autonegotiation signals are sent from the autonegotiation-capable Ethernet transceiver connected to the cable comprising the twisted pair. Transmitting the one or more autonegotiation signals during an attempt to identify an open cable is in response to a failure of the attempt to establish the Ethernet communication link. In other embodiments, a transmitter of the transceiver transmitting the one or more autonegotiation signals and a receiver of the transceiver receiving the waveforms are connected to the cable. In further embodiments, the transmitter is connected to the cable and the receiver is disconnected from the cable for each pulse of the one or more autonegotiation signals and the transmitter is disconnected from the cable and the receiver is connected to the cable between each pulse of the one or more autonegotiation signals. In other embodiments, the transmitter and the receiver are simultaneously connected to the cable.

In some embodiments, the autonegotiation signals include clock and/or data pulses adjusted to have a pulse width less than a projected propagation delay of signals traveling to an end of the cable and back. In other embodiments, determining that the received one or more waveforms are indicative of a reflected autonegotiation signal includes determining that the received one or more waveforms do not include a valid autonegotiation signal. In other embodiments, the method includes increasing an error counter in response to determining that the received one or more waveforms are invalid autonegotiation signals, and comparing a count of the error counter with an error threshold. In the embodiments, transmitting the open cable alert is in response to the count of the error counter exceeding the error threshold. In other embodiments, transmitting the one or more autonegotiation signals includes transmitting two or more autonegotiation signals and the error threshold corresponds to received waveforms corresponding to two or more transmitted autonegotiation signals. In some embodiments, each of one or more the autonegotiation signals include a Fast Link Pulse (“FLP”) and each FLP includes a plurality of pulses with an alternating series of a clock pulses and data pulses. The data pulses each include intended transmission rate information of the transceiver.

An apparatus for detecting an open circuit on a cable for 1GBASE-T and/or 10GBASE-T Ethernet communications includes a transmitter of an autonegotiation-capable Ethernet transceiver configured to transmit one or more autonegotiation signals during an attempt to identify an open cable. The transceiver is connected to a cable with a twisted pair. The apparatus includes a receiver of the transceiver configured to receive one or more waveforms from the cable, and a pulse analyzer of the transceiver configured to determine whether the received one or more waveforms are indicative of a reflected autonegotiation signal. The apparatus includes an open alert module configured to transmit an open cable alert in response to the pulse analyzer determining that a plurality of received waveforms are not valid autonegotiation signals.

In some embodiments, the apparatus includes the transmitter transmitting one or more autonegotiation signals during an attempt to establish an Ethernet communication link. The autonegotiation signals is sent from the autonegotiation-capable Ethernet transceiver connected to the cable with the twisted pair. Transmitting the one or more autonegotiation signals during an attempt to identify an open cable is in response to a failure of the attempt to establish the Ethernet communication link. In other embodiments, the transmitter of the transceiver transmitting the one or more autonegotiation signals and the receiver of the transceiver receiving the waveforms are connected to the cable. In other embodiments, the transmitter and the receiver are simultaneously connected to the cable.

In some embodiments, the autonegotiation signals include clock and/or data pulses adjusted to have a pulse width less than a projected propagation delay of signals traveling to an end of the cable and back. In other embodiments, the apparatus includes a counter module configured to increase an error counter in response to determining that the received one or more waveforms are invalid autonegotiation signals, and a counter comparison module configured to compare a count of the error counter with an error threshold. In the embodiments, the open alert module transmitting the open cable alert is in response to the count of the error counter exceeding the error threshold. In other embodiments, transmitting the one or more autonegotiation signals includes transmitting two or more autonegotiation signals and the error threshold corresponds to received waveforms corresponding to two or more transmitted autonegotiation signals. In other embodiments, each of one or more the autonegotiation signals includes a FLP and each FLP includes a plurality of pulses including an alternating series of a clock pulses and data pulses. The data pulses each include intended transmission rate information of the transceiver.

A program product for detecting an open circuit on a cable for 1GBASE-T and/or 10GBASE-T Ethernet communications includes a non-volatile computer readable storage medium storing code. The code is configured to be executable by a processor to perform operations that include transmitting one or more autonegotiation signals during an attempt to identify an open cable. The autonegotiation signals are sent from an autonegotiation-capable Ethernet transceiver connected to a cable with a twisted pair. The operations include receiving one or more waveforms from the cable, analyzing the received one or more waveforms, and transmitting an open cable alert in response to determining that the received one or more waveforms are indicative of a reflected autonegotiation signal.

In some embodiments, the operations include transmitting one or more autonegotiation signals during an attempt to establish an Ethernet communication link. The autonegotiation signals are sent from the autonegotiation-capable Ethernet transceiver connected to the cable with the twisted pair. Transmitting the one or more autonegotiation signals during an attempt to identify an open cable is in response to a failure of the attempt to establish the Ethernet communication link.

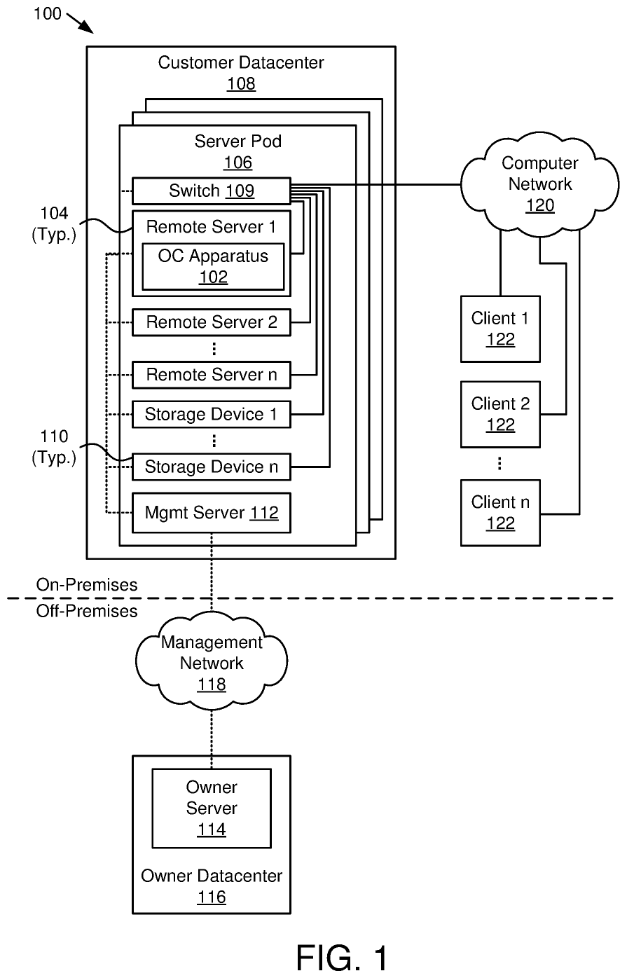

FIG. 1 is a schematic block diagram illustrating a system 100 for detecting an open circuit on a cable for 1GBASE-T and/or 10GBASE-T Ethernet communications, according to various embodiments. The system 100 includes an open circuit apparatus 102 in a remote server 104 of a server pod 106 of a customer datacenter 108. The server pod 106 includes one or more switches 109, storage devices 110, and the like and in some embodiments, includes a management server 112. The management server 112 is connected to an owner server 114 at an owner datacenter 116 through a management network 118. The servers 104 are connected to the switch 109, which connects to clients 122 over a computer network 120. The system 100 is described in more detail below.

The system 100 of FIG. 1 is a typical environment where 1GBASE-T and/or 10GBASE-T Ethernet communications are used with UTP and STP copper cables terminated with RJ45 jacks. The open circuit apparatus 102 provides a mechanism for determining if a UTP or STP copper cable has an open circuit without a service person physically going to the location of the cable. While FIG. 1 depicts a system 100 with a customer datacenter 108, other locations using 1GBASE-T and/or 10GBASE-T Ethernet communications may also benefit from the open circuit apparatus 102 in equipment connected using UTP/STP cables.

The open circuit apparatus 102 is depicted in a single remote server 104 for convenience, but it is understood that other devices, such as the switch 109, storage devices 110, the management server 112, and other equipment using 1GBASE-T and/or 10GBASE-T Ethernet communications and UTP/STP cables with RJ45 connectors may also include an open circuit apparatus 102. The devices 104, 109, 110, 112, etc. of a server pod 106 or other devices of a datacenter 108 are connected with various cables. Some of which may include UTP/STP cables with RJ45 connectors while other connections run higher speeds and may include DAC, AOC, etc. cables.

Often the devices 104, 109, 110, 112, etc. of a datacenter 108 include a management controller (not shown) connected to a management server 112. The management controllers are sometimes called a baseboard management controller (“BMC”). One form of a BMC is a Lenovo® XClarity® Controller (“XCC”). In some embodiments, the management server 112 is a Lenovo XClarity Administrator (“XCA”) or a Lenovo XClarity Orchestrator (“XCO”). Other management controllers are used in various systems 100. Having a management controller in the devices 104, 109, 110, 112, etc. of a datacenter 108 provides a mechanism for remote management, for example, through the owner server 114, which is connected to the management server 112 over a management network 118. In some embodiments, the owner server 114 includes a Lenovo XCO. Typically, the management network 118 is a private and/or secure network apart from a computer network 120 used for communication between the servers 104 and other equipment of the customer datacenter 108 and clients 122.

The management network 118 and computer network 120 may include wired connections, wireless connections, fiber connections, and the like. The management network 118 and computer network 120 may include a LAN, a WAN, a fiber channel network, a public network, such as the Internet, etc. and may include a combination of network types.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

When a network issue is present at the customer datacenter 108, access to the devices 104, 109, 110, 112, etc. of a datacenter 108, access to the management controllers and management server 112 over the management network 118 provides a mechanism for remote access and testing, including access to the open circuit apparatus 102. The open circuit apparatus 102 beneficially provides a mechanism to reduce the number of visits to the customer datacenter 108 by a service person. The open circuit apparatus 102, in some embodiments, transmits one or more autonegotiation signals during an attempt to identify an open cable. The autonegotiation signals are sent from an autonegotiation-capable Ethernet transceiver connected to a cable with a twisted pair. The cable may be a UTP/STP copper cable with a cat 5e or better rating and may be terminated with an RJ45 connector.

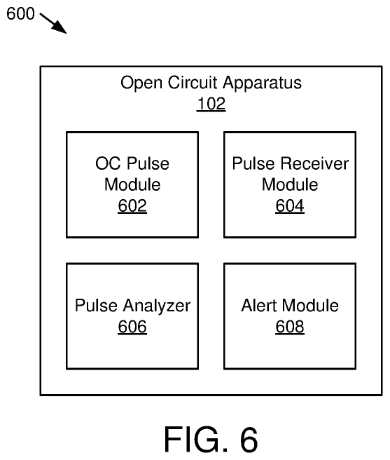

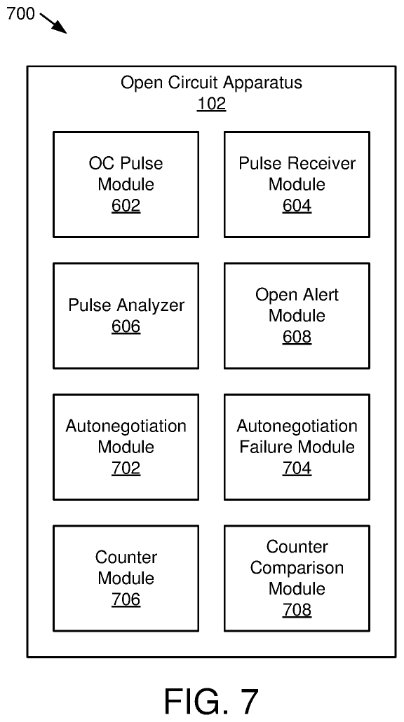

The open circuit apparatus 102, in the embodiments, receives one or more waveforms from the cable and analyzes the received waveforms. The open circuit apparatus 102 transmits an open cable alert in response to determining that the received one or more waveforms are indicative of a reflected autonegotiation signal. In some embodiments, the open circuit apparatus 102 transmits the one or more autonegotiation signals during an attempt to identify an open cable after a failure of autonegotiation, which includes transmitting one or more autonegotiation signals during an attempt to establish an Ethernet communication link. The autonegotiation signals are sent from the autonegotiation-capable Ethernet transceiver connected to the cable with the twisted pair. The open circuit apparatus 102 is described in more detail below with respect to the apparatuses 600, 700 of FIGS. 6 and 7.

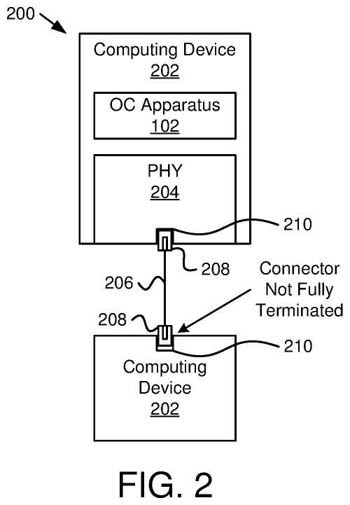

FIG. 2 is a schematic block diagram illustrating an apparatus 200 for detecting an open circuit on a cable for 1GBASE-T and/or 10GBASE-T Ethernet communications in a server, according to various embodiments. The apparatus 200 includes a computing devices 202 where one computing device 202 is depicted with an open circuit apparatus 102. In some embodiments, both computing devices 202 include an open circuit apparatus 102 and only one open circuit apparatus 102 is depicted for clarity.

Typically, a computing device 202 with networking capabilities includes a physical layer (“PHY”) 204. Again, only one computing device 202 is depicted with a PHY 204 for clarity, but it is understood that both computing devices 202 include a PHY 204. The computing devices 202 are connected with a cable 206. In embodiments described herein, the cable 206 is rated for 1GBASE-T and/or 10GBASE-T Ethernet communications and is copper UTP or STP cable and is not terminated with DAC, AOC or the like. Typically, the cable 206 is terminated with an RJ45 jack 208.

The computing devices 202 include a port 210 where the RJ45 jacks 208 are terminated. The apparatus 200 depicts the lower jack 208 not fully terminated in the port 210 of the lower computing device 202, which creates an open circuit. In some instances, the open circuit apparatus 102 is able to detect the open circuit, as described herein. The computing devices 202 include any computing device with a 1GBASE-T and/or 10GBASE-T Ethernet communications capability and a port 210 capable of receiving a connector, such as the RJ45 connector 208 of a copper cable with twisted pairs.

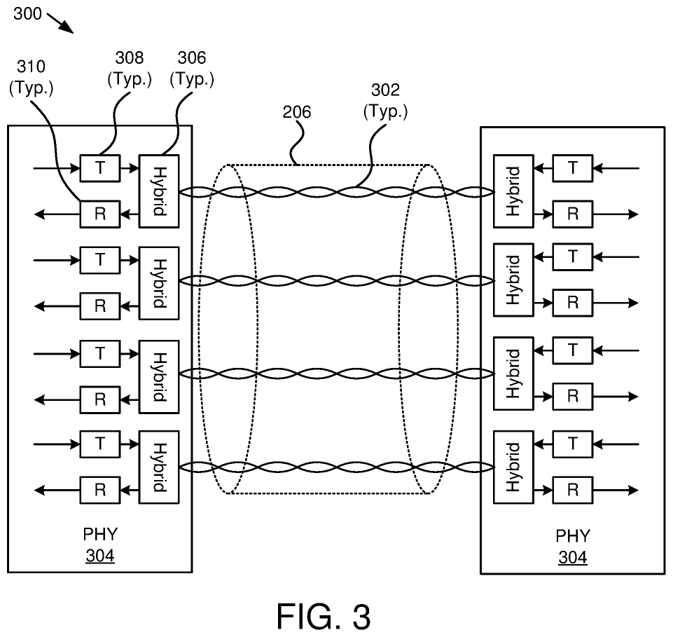

FIG. 3 is a schematic block diagram 300 illustrating one embodiment of a PHY 304 on each end of a 1GBASE-T and/or 10GBASE-T Ethernet communication capable cable 206, according to various embodiments. In some embodiments, the PHY 304 of FIG. 3 is substantially similar to the PHY 204 of FIG. 2, and PHY 304 and PHY 204 may be used interchangeably. The cable 206 includes four twisted pairs 302 of copper wire, which may be UTP or STP. Each twisted pair 302 terminates at a hybrid circuit 306 of the PHY 304, which connects to a transmitter 308 and a receiver 310. The connector 208 and port 210 are not shown. Having four twisted pairs 302 each terminated in a hybrid circuit 306 as depicted provides full duplex communications through each twisted pair 302 so that Ethernet packets flow in both directions on each twisted pair 302. The depicted configuration provides a four-lane data channel where data is split between each twisted pair 302.

In some embodiments, each PHY 304 includes all or part of an open circuit apparatus 102. In other embodiments, the open circuit apparatus 102 of a computing device 202 is external to the PHY 304 and directs or controls the PHY 304. One of skill in the art will recognize other ways to implement an open circuit apparatus 102 in conjunction with a PHY 304 of a computing device 202.

One feature of 1GBASE-T and 10GBASE-T Ethernet communications is an ability for autonegotiation. Often computing devices 202 with differing Ethernet speed capabilities are called upon to connect with other computing devices 202 with different Ethernet speed capabilities. For example, one computing device 202 may be 10GBASE-T capable, but may be connected to a 1GBASE-T or 100BASE-T (100 megabits per second) capable computing device 202. 10BASE-T and lower connections communicate using half-duplex mode where only one side is able to communicate at a time. 100BASE-T and higher connections are full-duplex capable and include autonegotiation. When PHYs 304 of mixed capabilities are used, settings on each side are changed so that both sides use a common communication standard. For optimum performance, each connection is tuned to produce a maximum bandwidth.

Autonegotiation provides a mechanism for both sides to communicate capabilities to each other and settle on a fastest communication mode. Early versions of autonegotiation send a normal pulse link (“NLP”) where a single pulse is sent from each side at a rate of a pulse every 16 milliseconds (“mS”). Once both sides receive NLP pulses, the sides communicate and set a communication standard used by both sides. Once both sides are set up for the common standard and after a normal handshake process, a communication link between the two PHYs 304 is enabled.

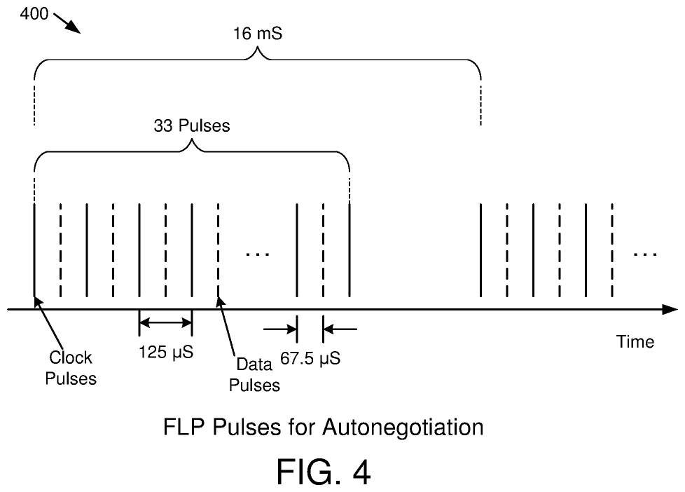

NLP was replaced with fast link pulses (“FLP”) where data is transmitted with the pulses to advertise communication capabilities. Older computing devices 202 use NLP. FIG. 4 is a diagram 400 illustrating a FLP for autonegotiation, according to various embodiments. FLP includes clock pulses separated by data pulses (dashed lines). FLP includes 33 pulses sent every 16 mS, which provides backward compatibility with NLP devices. The clock pulses are sent every 125 microseconds (“μS”) with data pulses spaced in between every 67.5 μS after a clock pulse. A data pulse between clock pulses represents a “1” and lack of a data pulse between clock pulses represents a “0.” With 33 total pulses, there are 16 data pulses separated by 17 clock pulses. The 16 data pulses represent a 16-bit code word used to convey capabilities of the PHY 304 transmitting the FLP.

In some embodiments, the first 5 bits (S0-S4) represent a selector field. In some example, a 00001 represents IEEE 802.3 and 00010 represents IEEE 802.9. The next 8 bits (A0-A7) are the technology code word fields. In some embodiments, AO is 10BASE-T, A1 is 10BASE-T Full Duplex, A2 is 100BASE-TX, A3 is 100BASE-TX Full Duplex, A4 is 100BASE-T4, A5 is a pause, A6 is asymmetric pause for full duplex, and A7 is reserved. The next bit is RF or remote fault, the next bit is ACK or acknowledgement, and the last bit is NP or next page. Each PHY 304 uses the data pulses to advertise capabilities, to acknowledge receipt of FLP pulses, etc. When a PHY 304 sends a certain number of FLP pulses and does not get a valid FLP pulse response, the communication link between the computing devices fails.

When a failure occurs, often a service person attempts to debug the issue remotely and often a service person must visit the location of the computing devices 202 with the failed Ethernet link to resolve the issue. Where the computing devices 202 include a TDR-capable PHY 304, a service person and/or programming in the PHY 304 may take advantage of the TDR to attempt to find the issue with the communication link between the computing devices 202. However, as mentioned above, having a TDR-capable PHY 304 is expensive compared to a PHY 304 without a TDR circuit. The open circuit apparatus 102 provides a mechanism to take advantage of an autonegotiation-capable PHY 304 to determine if there is an open circuit, which is often caused by an improperly terminated connection. An improperly terminated connection is a common networking issue.

Where the open circuit apparatus 102 is able to detect an open circuit, a lesser skilled person may be able to push the connector 208 into the port 210 and resolve the issue. Where the open circuit apparatus 102 is able to eliminate an open circuit as an issue or at least is unable to identify an open circuit, a service person may try other solutions and a service person may then go to the computing devices 202 with the communication link problem to resolve the issue.

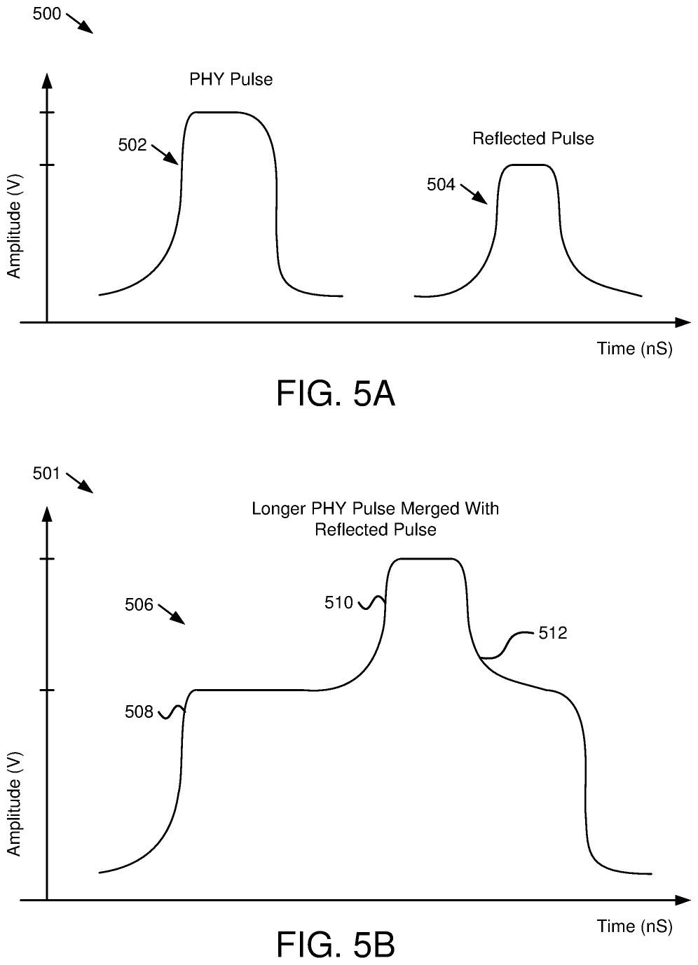

When a typical clock pulse or data pulse is transmitted by a PHY 304 and where an open circuit exists, when an FLP pulse reaches the open circuit, a reflected wave is generated that is a positive voltage waveform that moves back to the source of the clock or data pulse. FIG. 5A is a diagram 500 illustrating a PHY pulse 502 of an autonegotiation signal and a reflected waveform 504, according to various embodiments. The PHY pulse 502, in some embodiments, is a FLP pulse, a NLP pulse, or a modified FLP or NLP pulse transmitted by the PHY 304 and the reflected waveform 504 is a pulse that forms at the open circuit and traverses back to the PHY 304 sending the PHY pulse 502. The hybrid circuit 306 and receiver 310 detect and read the reflected waveform 504. The reflected waveform 504 typically has a lower amplitude than the PHY pulse 502 and is typically distorted.

When a cable 206 is properly terminated, impedance of the termination matches cable impedance so that a transmitted pulse is absorbed and not reflected. While impedance matching is typically not perfect, any reflected waveform would be very small or negligible. When a first side is transmitting autonegotiation pulses to a second side on a properly terminated cable 206, the second side receives the autonegotiation pulses without reflection. However, the second side may also be transmitting autonegotiation pulses. Where the cable 206 is properly terminated, not damaged, spliced, etc., so the first end will receive the autonegotiation pulses with enough signal integrity so that the receiver 310 will detect valid autonegotiation pulses. Typically, reflected signals from an open circuit will have a lower amplitude and will be distorted.

Note that during autonegotiation and where an open circuit exists, the PHY 304 transmitting the FLP pulses will receive reflected waves 502 so that a valid FLP signal is not detected by the receiver 310 of the PHY 304. No acknowledgement is received and autonegotiation fails. The open circuit apparatus 102 then sends PHY pulses 502 and the receiver 310 of the PHY 304 sending the PHY pulses 502 is set to detect the reflected waveforms 504.

Note that a typical clock pulse or data pulse is 100 nanoseconds and there is a possibility that a reflected waveform merges with an FLP pulse being transmitted creating a misshapen pulse 506 that is detected by the receiver 310 of the PHY 304 transmitting the FLP pulse, as depicted in FIG. 5B. Initially, the pulse 506 rises to a particular voltage (see 508). If the reflected waveform 504 returns before the FLP pulse concludes, the waveforms merge and voltage rises 510 above the transmission voltage. Eventually, the voltage drops 512 and eventually concludes. Note that the pulse 506 of FIG. 5B merely represents the principle of a reflected waveform 504 merging with a PHY pulse 502 and is not intended to be an accurate depiction of an actual merged pulse 506. One of skill in the art will recognize shapes of actual PHY pulses 502 merged with reflected waveforms 504.

FIG. 6 is a schematic block diagram illustrating an apparatus 600 for detecting an open circuit on a cable for 1GBASE-T and/or 10GBASE-T Ethernet communications, according to various embodiments. The apparatus 600 includes an open circuit pulse module 602, a pulse receiver module 604, a pulse analyzer 606, and an open alert module 608, which are described below. In various embodiments, all or a portion of the apparatus 600 is implemented in hardware circuits. In some examples, the apparatus 600 is built into the PHY 204 and includes hardware circuits to implement all or portion of the modules/analyzer 602, 604, 606, 608. In some embodiments, all or a portion of the apparatus 600 is implemented with a programmable hardware device, such as a programmable logic array, an FPGA, etc. In other embodiments, all or a portion of the apparatus 600 is implemented in code stored on non-transitory computer readable storage media, which is executable on a processor. For example, the code may be executable by a processor of the computing device 202, a processor of a management controller of the computing device, etc. and controls the PHY 204 of the computing device 202. One of skill in the art will recognize other ways to implement the apparatus 600.

The apparatus 600 includes an open circuit pulse module 602 configured to transmit one or more autonegotiation signals during an attempt to identify an open cable 206. The autonegotiation signals are sent from an autonegotiation-capable Ethernet transceiver connected to a cable 206 with a twisted pair 302. In some embodiments, the transceiver is a PHY 204 or includes a PHY 204. In some embodiments, the open circuit pulse module 602 is a transmitter (e.g. 308) of the PHY 304 or is included in the transmitter 308 of the PHY 304.

In some embodiments, the open circuit pulse module 602 transmits one or more NLP signals. In other embodiments, the open circuit pulse module 602 transmits one or more FLP signals. A goal of the embodiments described herein are to detect an open circuit using a PHY 204 without a TDR circuit. Ideally, the PHY 204 is a standard PHY that is reprogrammed to detect an open circuit.

In some embodiments, the open circuit pulse module 602 transmits autonegotiation signals on a single twisted pair 302 of the cable 206. In other embodiments, the open circuit pulse module 602 transmits autonegotiation signals on two, three or four twisted pairs 302 of the cable 206.

In some embodiments, the transmitter of the transceiver transmitting the one or more autonegotiation signals and a receiver of the transceiver receiving the waveforms are connected to the cable 206. For example, the transmitter may be the transmitter 308 of FIG. 3 and the receiver is the receiver 310 of FIG. 3, which are connected to a hybrid circuit 306 so that both the transmitter 308 and the receiver 310 are connected the same twisted pair 302. In some embodiments, the transmitter and the receiver are simultaneously connected to the cable 206. In other embodiments, the transmitter is connected to the cable 206 and the receiver is disconnected from the cable 206 for each pulse of the one or more autonegotiation signals and the transmitter is disconnected from the cable 206 and the receiver is connected to the cable 206 between each pulse of the one or more autonegotiation signals.

The propagation delay in cat 5e, cat 6, etc. cable used for 1GBASE-T and 10GBASE-T Ethernet communications is around 5 nS per meter and is as high as 5.38 nS per meter. The cables 206 are typically limited to 100 meters. In a datacenter the cables 206 are often short. Looking at a 1 meter cable, an autonegotiation pulse will travel down and back for an open circuit and would travel 2 meters. Thus, the propagation delay for reflected waveforms 504 would be about (5 nS/m)(2 m)=10 nS. FLP pulses are 100 nS with a maximum of 200 nS so a reflected waveform 504 would merge with the FLP pulse before completion of the FLP pulse, as depicted in FIG. 5B. For a 10 meter cable 206, the propagation delay would be (5 nS/m)(20 m)=100 nS. Thus, for cables 206 longer than about 10 meters, the reflected waveforms 504 typically would not merge with the transmitted FLP pulses 502 where the FLP pulses 502 are 100 nS or less.

In some embodiments, the autonegotiation signals include clock and/or data pulses adjusted to have a pulse width less than a projected propagation delay of signals traveling to an end of the cable 206 and back. In some examples, the NLP or FLP pulses are shortened to accommodate cables 206 shorter than about 10 meters. For example, for a 1 meter cable 206 the propagation delay of the reflected waveform 504 is about 10 nS so the FLP or NLP pulses, in some embodiments, are less than 10 nS. Where the FLP or NLP pulses are maintained at around 100 nS, the FLP/NLP pulses would merge with the reflected waveforms resulting in a pulse longer than the width of the FLP/NLP pulse being transmitted, such as depicted in FIG. 5B. In some embodiments, the resulting pulse 506 would have a voltage that would spike about the amplitude of the transmitted FLP/NLP pulse. Where the pulse widths are modified, the open circuit pulse module 602 transmits modified autonegotiation signals. For example, the open circuit pulse module 602 may transmit FLP pulses where each pulse is shortened.

The apparatus 600 includes a pulse receiver module 604 configured to receive one or more waveforms from the cable 206. In some embodiments, the pulse receiver module 604 receives the one or more waveforms from the cable 206 from the receiver 310 and/or hybrid circuit 306. In other embodiments, the pulse receiver module 604 includes the receiver 310 and/or hybrid circuit 306. In other embodiments, the receiver 310 and/or hybrid circuit 306 includes the pulse receiver module 604.

The apparatus 600 includes a pulse analyzer 606 configured to analyze the received one or more waveforms. In some embodiments, the pulse analyzer 606 analyzes the received one or more waveforms to detect reflected waveforms. For example, the received waveforms are typically attenuated and distorted and the pulse analyzer 606 determines that the received waveforms are not valid autonegotiation pulses from a computing device 202 on the other end of the cable 206. In other embodiments, the pulse analyzer 606 analyzes the received waveforms and is able to detect if the received waveforms are reflected waveforms or valid autonegotiation pulses using hardware circuits, comparators, etc. used typically in an autonegotiation detection procedure and not a TDR circuit. In some examples, the pulse analyzer 606 uses standard PHY circuitry in distinguishing between a reflected waveforms and valid autonegotiation pulses without the use of a TDR circuit.

In some embodiments, the receiver 310 detects the transmitted autonegotiation pulses from the transmitter 308 along with the received one or more waveforms and the pulse analyzer 606 is able to ignore the transmitted autonegotiation pulses and analyze the received waveforms. In some embodiments, the pulse analyzer 606 analyzes pulse timing and/or amplitude level of received waveforms. In other embodiments, the pulse analyzer 606 analyzes pulse width. In other embodiments, the pulse analyzer 606 detects and/or analyzes voltage levels above the voltage level of the transmitted pulses and is able to detect a voltage above a threshold that is indicative of a merged pulse 506. One of skill in the art will recognize other ways for the pulse analyzer 606 to detect reflected waveforms.

The apparatus 600 includes an open alert module 608 configured to transmit an open cable alert in response to the pulse analyzer 606 determining that the received one or more waveforms are indicative of a reflected autonegotiation signal. In some embodiments, the open alert module 608 transmits the open cable alert when the pulse analyzer 606 determines that the received waveforms are reflected waveforms and not valid autonegotiation pulses, for example, from a computing device 202 at the other end of the cable 206.

In some embodiments, the open alert module 608 sends an open cable alert to a system administrator through the management network 118. In other embodiments, the open alert module 608 sends an open cable alert as an electronic message, such as by email, text message, direct message, etc. In other embodiments, the open alert module 608 sends an open cable alert in the form of an interrupt. In other embodiments, the open alert module 608 sends an open cable alert in the form of a signal that causes the computing device 202 transmitting the autonegotiation pulses to perform some action. One of skill in the art will recognize other forms of the open cable alert and destinations for the open cable alert.

FIG. 7 is a schematic block diagram illustrating another apparatus 700 for detecting an open circuit on a cable for 1GBASE-T and/or 10GBASE-T Ethernet communications, according to various embodiments. The apparatus 700 includes an open circuit apparatus 102 with an open circuit pulse module 602, a pulse receiver module 604, a pulse analyzer 606, and an open alert module 608, which are substantially similar to those described above in relation to the apparatus 600 of FIG. 6. In various embodiments, the apparatus 700 includes an autonegotiation module 702, an autonegotiation failure module 704, a counter module 706, and/or a counter comparison module 708, which are described below. In various embodiments, the apparatus 700 is implemented similar to the apparatus 600 of FIG. 6, as described above.

The apparatus 700 includes, in some embodiments, an autonegotiation module 702 configured to transmit one or more autonegotiation signals during an attempt to establish an Ethernet communication link. The autonegotiation signals are sent from the autonegotiation-capable Ethernet transceiver connected to the cable 206 with the twisted pair 302. The autonegotiation module 702 transmits the autonegotiation signals expecting a response from the computing device 202 at the other end of the cable 206. After not receiving valid autonegotiation signals for a period of time or other abnormality, the autonegotiation module 702 determines that the autonegotiation has failed.

The apparatus 700, in some embodiments, includes an autonegotiation failure module 704 configured to trigger the open circuit pulse module 602 to send the autonegotiation signals during an attempt to identify an open cable 206 in response to the autonegotiation module 702 failing to establish an Ethernet communication link. Thus, the autonegotiation failure module 704 starts the process to determine if the cable 206 has an open circuit.

The apparatus 700, in some embodiments, includes a counter module 706 configured to increase an error counter in response to determining that the received one or more waveforms are invalid autonegotiation signals and a counter comparison module 708 configured to compare a count of the error counter with an error threshold. In the embodiments, the open alert module 608 transmits the open cable alert is in response to the counter comparison module 708 determining that the count of the error counter exceeds the error threshold.

In some embodiments, the counter module 706 increases the error counter in response to each pulse transmitted by the open circuit pulse module 602 and a resultant received waveform not being a valid autonegotiation pulse. In other embodiments, the counter module 706 increases the error counter in response to each series of pulses transmitted by the open circuit pulse module 602 and resultant received waveforms not being valid autonegotiation pulses. For example, the counter module 706 may increase the error counter after a full FLP sequence. One of skill in the art will recognize other ways for the counter module 706 to increase the error counter.

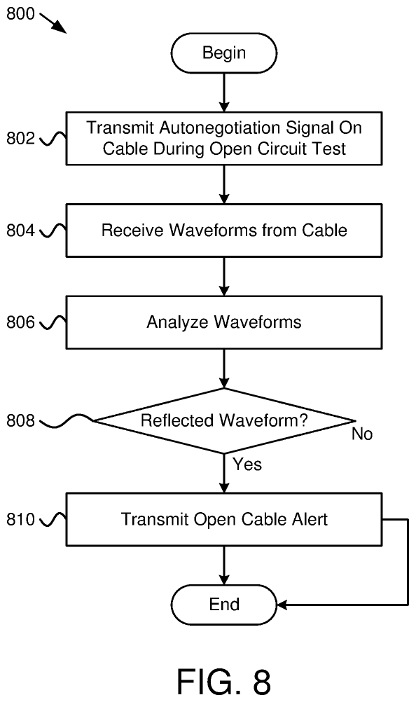

FIG. 8 is a schematic flow chart diagram illustrating one embodiment of a method 800 for detecting an open circuit on a cable for 1GBASE-T and/or 10GBASE-T Ethernet communications, according to various embodiments. The method 800 begins and transmits 802 one or more autonegotiation signals during an attempt to identify an open cable 206. The autonegotiation signals are sent from an autonegotiation-capable Ethernet transceiver (e.g. PHY 204) connected to a cable 206 with a twisted pair 302. The method 800 receives 804 one or more waveforms from the cable 206, analyzes 806 the received one or more waveforms, and determines 808 if the received one or more waveforms are indicative of a reflected autonegotiation signal.

If the method 800 determines 808 that the received one or more waveforms are not indicative of a reflected autonegotiation signal, e.g. the received waveforms are a valid autonegotiation signal, no waveforms are received, etc., the method 800 ends. If the method 800 determines 808 that the received one or more waveforms are indicative of a reflected autonegotiation signal, for example by amplitude, timing, pulse width, etc., the method 800 transmits 810 an open cable alert, and the method 800 ends. In various embodiments, all or a portion of the method 800 is implemented using the open circuit pulse module 602, the pulse receiver module 604, the pulse analyzer 606, and/or the open alert module 608.

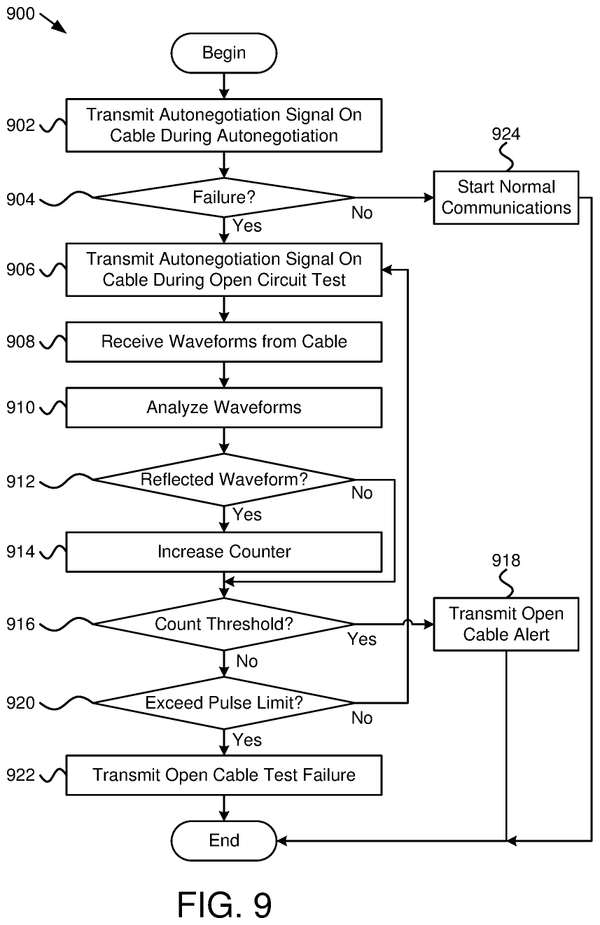

FIG. 9 is a schematic flow chart diagram illustrating another method 900 for detecting an open circuit on a cable for 1GBASE-T and/or 10GBASE-T Ethernet communications, according to various embodiments. The method 900 begins and transmits 902 autonegotiation signals during an attempt to establish an Ethernet communication link. The autonegotiation signals are sent from the autonegotiation-capable Ethernet transceiver (e.g. PHY 204) connected to a cable 206 with a twisted pair 302. The method 900 determines 904 if there is a failure in establishing an Ethernet link through the cable 206. If the method 900 determines 904 that there is a failure in establishing an Ethernet link through the cable 206, the method 900 transmits 906 one or more autonegotiation signals during an attempt to identify an open cable. The autonegotiation signals are sent from the autonegotiation-capable Ethernet transceiver connected to the cable 206 with the twisted pair 302.

The method 900 receives 908 one or more waveforms from the cable 206, analyzes 910 the received one or more waveforms, and determines 912 if the received one or more waveforms are indicative of a reflected autonegotiation signal. If the method 900 determines 912 that the received one or more waveforms are indicative of a reflected autonegotiation signal, for example by amplitude, timing, pulse width, etc., the method 900 increases 914 an error counter and determines 916 if the error counter exceeds an error threshold. If the method 900 determines 916 that the error counter exceeds the error threshold, the method 900 transmits 918 and open cable alert, and the method 900 ends.

If the method 900 determines 916 that the error counter does not exceed the error threshold, the method 900 determines 920 if a pulse count exceeds a pulse limit. The pulse limit, in various embodiments, is an FLP sequence, several FLP sequences, a number of NLP pulses, etc. deemed sufficient to identify an open circuit. If the method 900 determines 920 that the pulse count does not exceed the pulse limit, the method 900 returns and continues to transmit 906 autonegotiation signals. If the method 900 determines 920 that the pulse count exceeds the pulse limit, the method 900 transmits 922 an open cable test failure alert, and the method 900 ends. Not detecting an open circuit after failure trying to establish an Ethernet communication link is indicative of another issue causing the failure to establish the Ethernet communication link, such as a short circuit, a failed component, etc.

If the method 900 determines 904 that an Ethernet link through the cable 206 has been established, the method 900 starts 924 normal communications over the cable 206, and the method 900 ends. In various embodiments, all or a portion of the method 900 is implemented using the open circuit pulse module 602, the pulse receiver module 604, the pulse analyzer 606, the open alert module 608, the autonegotiation module 702, the autonegotiation failure module 704, the counter module 706, and/or the counter comparison module 708.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
transmitting one or more autonegotiation signals during an attempt to identify an open cable, the autonegotiation signals sent from an autonegotiation-capable Ethernet transceiver connected to a cable comprising a twisted pair;
receiving one or more waveforms from the cable;
analyzing the received one or more waveforms; and
transmitting an open cable alert in response to determining that the received one or more waveforms are indicative of a reflected autonegotiation signal.

2. The method of claim 1, further comprising:
transmitting one or more autonegotiation signals during an attempt to establish an Ethernet communication link, the autonegotiation signals sent from the autonegotiation-capable Ethernet transceiver connected to the cable comprising the twisted pair,
wherein transmitting the one or more autonegotiation signals during an attempt to identify an open cable is in response to a failure of the attempt to establish the Ethernet communication link.

3. The method of claim 1, wherein a transmitter of the transceiver transmitting the one or more autonegotiation signals and a receiver of the transceiver receiving the waveforms are connected to the cable.

4. The method of claim 3, wherein the transmitter is connected to the cable and the receiver is disconnected from the cable for each pulse of the one or more autonegotiation signals and the transmitter is disconnected from the cable and the receiver is connected to the cable between each pulse of the one or more autonegotiation signals.

5. The method of claim 3, wherein the transmitter and the receiver are simultaneously connected to the cable.

6. The method of claim 1, wherein the autonegotiation signals comprise clock and/or data pulses adjusted to have a pulse width less than a projected propagation delay of signals traveling to an end of the cable and back.

7. The method of claim 1, wherein determining that the received one or more waveforms are indicative of a reflected autonegotiation signal comprises determining that the received one or more waveforms do not comprise a valid autonegotiation signal.

8. The method of claim 1, further comprising:
increasing an error counter in response to determining that the received one or more waveforms are invalid autonegotiation signals; and
comparing a count of the error counter with an error threshold,
wherein transmitting the open cable alert is in response to the count of the error counter exceeding the error threshold.

9. The method of claim 8, wherein transmitting the one or more autonegotiation signals comprises transmitting two or more autonegotiation signals and the error threshold corresponds to received waveforms corresponding to two or more transmitted autonegotiation signals.

10. The method of claim 1, wherein each of one or more the autonegotiation signals comprises a Fast Link Pulse (“FLP”) and wherein each FLP comprises a plurality of pulses comprising an alternating series of a clock pulses and data pulses, wherein the data pulses each comprise intended transmission rate information of the transceiver.

11. An apparatus comprising:
a transmitter of an autonegotiation-capable Ethernet transceiver configured to transmit one or more autonegotiation signals during an attempt to identify an open cable, the transceiver connected to a cable comprising a twisted pair;
a receiver of the transceiver configured to receive one or more waveforms from the cable;
a pulse analyzer of the transceiver configured to determine whether the received one or more waveforms are indicative of a reflected autonegotiation signal; and
an open alert module configured to transmit an open cable alert in response to the pulse analyzer determining that a plurality of received waveforms are not valid autonegotiation signals.

12. The apparatus of claim 11, the apparatus comprises:
the transmitter transmitting one or more autonegotiation signals during an attempt to establish an Ethernet communication link, the autonegotiation signals sent from the autonegotiation-capable Ethernet transceiver connected to the cable comprising the twisted pair,
wherein transmitting the one or more autonegotiation signals during an attempt to identify an open cable is in response to a failure of the attempt to establish the Ethernet communication link.

13. The apparatus of claim 11, wherein the transmitter of the transceiver transmitting the one or more autonegotiation signals and the receiver of the transceiver receiving the waveforms are connected to the cable.

14. The apparatus of claim 13, wherein the transmitter and the receiver are simultaneously connected to the cable.

15. The apparatus of claim 11, wherein the autonegotiation signals comprise clock and/or data pulses adjusted to have a pulse width less than a projected propagation delay of signals traveling to an end of the cable and back.

16. The apparatus of claim 11, further comprising:
a counter module configured to increase an error counter in response to determining that the received one or more waveforms are invalid autonegotiation signals; and
a counter comparison module configured to compare a count of the error counter with an error threshold,
wherein the open alert module transmitting the open cable alert is in response to the count of the error counter exceeding the error threshold.

17. The apparatus of claim 16, wherein transmitting the one or more autonegotiation signals comprises transmitting two or more autonegotiation signals and the error threshold corresponds to received waveforms corresponding to two or more transmitted autonegotiation signals.

18. The apparatus of claim 11, wherein each of one or more the autonegotiation signals comprises a Fast Link Pulse (“FLP”) and wherein each FLP comprises a plurality of pulses comprising an alternating series of a clock pulses and data pulses, wherein the data pulses each comprise intended transmission rate information of the transceiver.

19. A program product comprising a non-volatile computer readable storage medium storing code, the code being configured to be executable by a processor to perform operations comprising:
transmitting one or more autonegotiation signals during an attempt to identify an open cable, the autonegotiation signals sent from an autonegotiation-capable Ethernet transceiver connected to a cable comprising a twisted pair;
receiving one or more waveforms from the cable;
analyzing the received one or more waveforms; and
transmitting an open cable alert in response to determining that the received one or more waveforms are indicative of a reflected autonegotiation signal.

20. The program product of claim 19, the code further configured to be executable by a processor to perform operations comprising:
transmitting one or more autonegotiation signals during an attempt to establish an Ethernet communication link, the autonegotiation signals sent from the autonegotiation-capable Ethernet transceiver connected to the cable comprising the twisted pair,
wherein transmitting the one or more autonegotiation signals during an attempt to identify an open cable is in response to a failure of the attempt to establish the Ethernet communication link.
